(19) United States
(12) Patent Application Publication
(10) Pub. No.: US 2021/0316360 A1
(43) Pub. Date: Oct. 14, 2021

(54) MANUFACTURING PROCESS OF CAMSHAFT WITH FUNCTIONAL COMPONENT AS INSERT OF ASSEMBLY AND THE CAMSHAFT OBTAINED WITH IT

(71) Applicant: Arbomex, S.A. DE C.V., Celaya (MX)

(72) Inventors: Juan Ignacio Castro Sosa, Celaya (MX); Marco Antonio Vera Vázquez, Celaya (MX); Sergio Ávila Gloria, Celaya (MX); José Antonio Laborde de la Peña, Celaya (MX)

(73) Assignee: Arbomex, S.A. DE C.V., Celaya (MX)

(21) Appl. No.: 17/350,886

(22) Filed: Jun. 17, 2021

Related U.S. Application Data
(62) Division of application No. 16/316,376, filed on Jan. 9, 2019.

(30) Foreign Application Priority Data
Aug. 23, 2016 (MX) MX/A/2016/010930

(51) Int. Cl. B22D 19/04; B22C 9/02; F01L 1/047; F16H 53/02; B22D 15/00; B22D 19/00

(52) U.S. Cl. CPC B22D 19/04; B22C 9/02; F01L 1/047; F01L 2303/00; B22D 15/00; B22D 19/00; F16H 53/025

(57) ABSTRACT

The present invention refers to a camshaft with a functional component as an assembly insert and the process of manufacturing said camshaft, wherein said camshaft has at least one functional, component integrated in the camshaft body, taking into account that the material of the functional component and the shaft body are of different materials; and wherein one or more functional components comprises a body of A-type material having an internal bore of suitable geometry to pass through it a B-type melt in a casting process; gripping means which achieve a mechanical, grip between both materials, A-type material and B-type molten material, to give mechanical grip in the longitudinal and circumferential direction with respect to the camshaft body.

### TECHNICAL FEILD OF THE INVENTION

The present invention relates to a camshaft with a functional component as an integrated insert as casting and the manufacturing process.

More specifically, the invention relates to a process for the production of camshafts with at least one functional component integrated in the shaft body, taking into account that the material of both the functional component and the body are of different materials; as well as camshafts produced by this process for internal combustion engines.

### BACKGROUND OF THE INVENTION

In the state of the art, a number of processes are known for the manufacture of camshafts, in their most common version camshafts are manufactured from one-piece iron casting; processes for the manufacture thereof are also known by the assembly of the different functional components of the camshaft in a tube, in order to obtain the final part.

Following the chronology for the manufacturing camshafts, the first ones were made of cast iron, because the properties of this material were sufficient for the functional requirements of the internal combustion engines of those times; this technology is still in use. The process of manufacturing these camshafts consists of generating a sand mold that forms the negative design of the shaft to be manufactured, that is, that it forms the silhouette of the shaft and that in turn has a feed channel through which the molten material will enter. Once the same mold is generated, the molten iron is emptied through the feed channel, the molten iron will take the shape of the mold and once cooled it will generate the desired shaft.

In this same line, some variants of this type of camshaft that appeared later carry a hole in the body, with the purpose of reducing the weight of the same to improve the performance of the internal combustion engine. This process varies from the previous one in the fact that, inside the sand mold a glass or sand element is placed, called core, which will avoid the entry of the molten material in such area, thus leaving a hollow in the desired place of the shaft generated.

When the demands of the internal combustion engines began to change, requiring a greater resistance to wear and or compress strength of its components beyond what had been achieved so far through the hardening processes such as flame, induction, TIG (tungsten inert gas), and austempered; combined with the requirement of a lower weight, the industry developed the camshafts assembled, that is, all the components of the camshaft are assembled one by one in a tube (or at the same time—hydraulic hydroforming), all of them usually made of steel.

In the state of the art for the assembled shafts, several assembly processes appeared, changing between them the way to achieve the mechanical grip between the components and the tube, the processes ranging from one involving the knurling of tube and grooving of functional components, to another process where the functional components are heated to dilate them and slide them through the tube and then the part contracts.

Taking the last process as an example, this is achieved by manufacturing separately each of the components of the shaft, such as cams, supports, tail, nose, drags and the tube where ail the previous ones are assembled; the manufacturing process of these varies according to their complexity, being able to be machined, sintered, forged or printed. Once having the aforementioned components, all the components are transferred to the assembly cell, where the component that will serve as a reference for the location and assembly of all others is assembled by mechanical pressure (press fit), usually it is the nose, and the adjustment is generated due to the mechanical interference between both parts.

After having the tube with the reference component assembled, the tube is placed vertically and one by one the missing components are placed, which are heated previously and assembled one by one; the heating is done through an induction coil (magnetic field) by the inner bore of each component.

Once heated, the component is taken and placed in the tube body, in the longitudinal and angular position required according to the final design. Once in place, the piece is cooled. The process of heating the components is to expand the inner diameter to avoid the design interference and can slip through the tube, and when cooled the diameter will return to its original size. It should be noted that there is also a designed mechanical interference between the pipe diameter and the component hole to ensure mechanical grip.

Having completed the assembly of all the components that are attached to the shaft, it is usually done to assemble the tail, which comes under mechanical pressure as well as the nose. Upon completion of this, the assembled shaft is finished and ready to continue its machining process as required by the final design.

In series production for assembled camshafts, these processes require a large investment in technology and require specific machinery and equipment. Taking as a reference the process described above, this technology consists of the robotic arms that will assemble the parts, since extreme heating and placement of the components requires extreme precision and a human operator could not achieve such; it also refers to the internal borehole heating machine of the components. All this investment of technology and machinery represents a disadvantage in terms of the final cost of the part and the speed of manufacture.

Another disadvantage of this assembled camshaft process is that in larger shaft diameters as required, for example, for commercial vehicle engines, the forces necessary for assembly increase disproportionately, as well as the time required for assembly the size of robots and heating machines is increasing, and therefore the cost of manufacturing is also increasing due to the machinery required to achieve this.

Taking into account the above-described background, the present invention proposes a solution to the present technical problems by providing a manufacturing process; for obtaining a camshaft which combines the benefits of the camshafts manufactured through the foundry and those manufactured by assembly, that is, to have a higher speed of manufacture, not being limited by the size of the camshaft, obtaining a complete piece from the beginning, increasing the resistance of the functional component that requires it through that this same component is of another material and is inserted directly from the molding process prior to the casting and in turn obtaining the required lightness that is so much sought in the internal combustion engine.

The objective of the invention is to provide economical and capable of being used in series on an industrial scale for the manufacture of camshafts with inserted functional components such as cams, supports, drive wheels, control discs, for the production of camshafts. The functional components must be able to be produced with materials of different characteristics and properties related to other materials and the connection between the functional components and the carrier shaft must exhibit a great mechanical resistance in the circumferential direction (torque transmission) and in the longitudinal direction of the shaft carrier.

### DESCRIPTION OF THE INVENTION

### Brief Description of the Drawings

FIG. 1 is a front view of the functional component of the camshaft of the invention.

FIG. 2 is an upper perspective view of the functional component of the camshaft of the invention.

FIG. 3 is a cross-sectional view of the upper perspective view of the functional component of the camshaft of the invention.

FIG. 4a illustrates a cross-section of mold parts for manufacturing the camshaft of the present invention and one of the manufacturing steps thereof.

FIG. 4b illustrates a perspective cross-section of the mold parts for manufacturing the camshaft of the present invention and one of the manufacturing steps thereof.

FIG. 5a illustrates a cross-section of the mold parts for manufacturing the camshaft of the present invention and one of the manufacturing steps thereof.

FIGS. 5b and 5c, illustrate a perspective cross-section of the mold parts for manufacturing the camshaft of the present invention and one of the manufacturing steps thereof.

FIG. 6 illustrates the closure of the mold with the functional component therein and prior to casting of the casting material.

FIG. 7a illustrates the closure of the mold with the functional component therein and with the casting material.

FIG. 7b is a perspective view of the closure of the mold with the functional component therein and with the casting material.

FIG. 8a is a front perspective view of the camshaft: obtained by the process of the present invention.

FIG. 8b is a rear perspective view of the camshaft obtained by the process of the present invention.

### DETAILED DESCRIPTION OF THE INVENTION

The present invention relates to a camshaft (30) with a functional component as an assembly insert and the manufacturing process.

More specifically, the present invention relates to a process for the industrial scale production of camshafts manufactured by the casting process with at least one functional component (1) as an assembly insert capable of withstanding the mechanical forces in the circumferential direction (torque transmission) and in the longitudinal direction of the carrier shaft, taking advantage of the rapid fabrication of the cast iron process and the advantage of having the elements subject to higher stresses made, preferably of steel, as in process of assembled shafts.

The functional components such as the cams, the supports, the drive wheels, the control discs, are produced separately, by some manufacturing process such as machining, forging, sintering or printing of a A-type material, preferably steel, they have an internal cavity (10) of suitable geometry through which the B type cast material, preferably iron, passes to be joined to the shaft made by casting during the solidification process, and thus allow the correct fastening for torque transmission and longitudinal gripping.

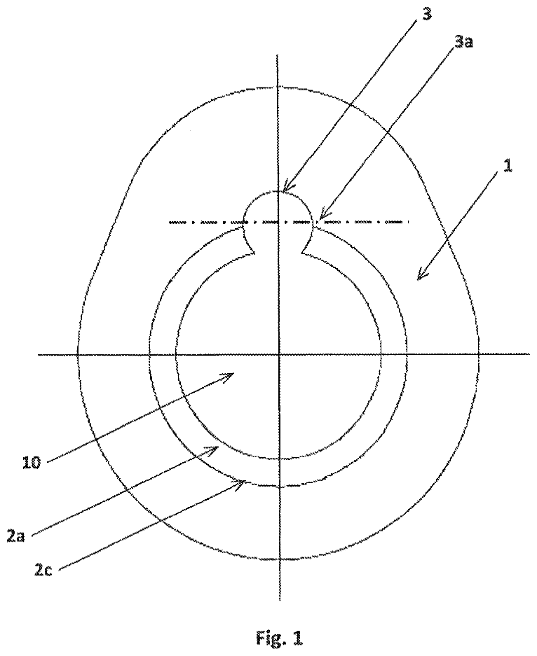

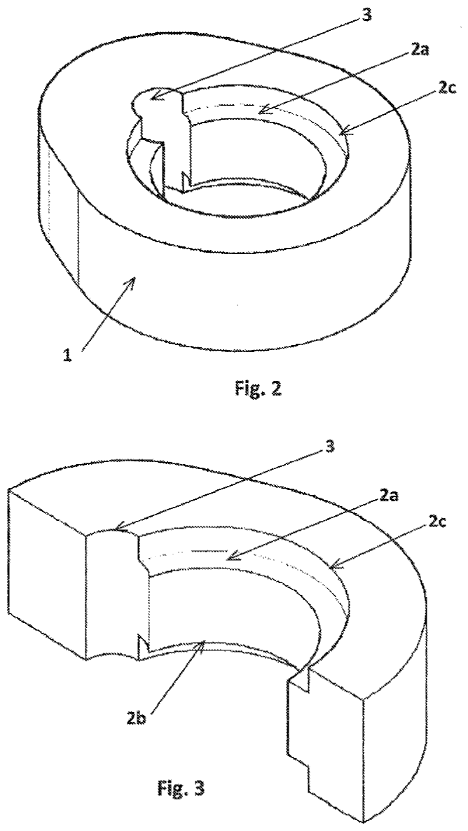

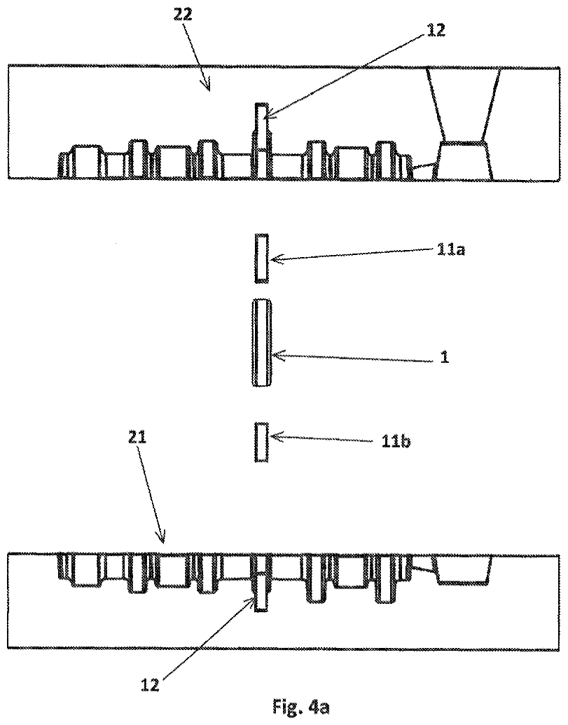

As shown in FIGS. 1-3, the functional component (1) comprises gripping means consisting of the aforementioned internal hollow geometry (10) for said functional components (1) and consisting of a bore past through the component (1), two steps (2a, 2b) are generated from the center of the track and towards the outside of the track, one on each side and a larger diameter, which, serve to give mechanical grip in the longitudinal direction. Then, along the circumferences (2c) generated by the borehole and the steps (2a, 2b), at least one borehole (3) of smaller diameter is generated, where its horizontal central axis (3a) is tangent to the circumference (2c) generated by the steps (2a, 2b), this bore (3) will serve to give mechanical grip in the circumferential direction.

In turn, some preforms called heaters (11a, 11b) are produced separately, of foam material (made by the lost foam process) or similar material useful like plastic or others, which will allow hot metal pass and serve to heat each of the functional components (1). These heaters (11a, 21b) depend on the size and shape of the geometry of each functional component (1), but always keeping in mind that they must cover at least 80% of the upper and lower surface of component (1) and must cover the edges in the change of section that is present in the geometry of the functional component, i.e. the change that occurs between the upper or lower face and its nearest side.

The function of these heaters (11a, 11b) is to heat the functional component (1) from the outside of its geometry, since the inside will be heated by the melted material passing through the bore (3) and will fill up the internal bore (10). Since the edges or section changes are points where it is easier to lose heat by the thermodynamic laws, that is why they must be covered with the heaters (11a, 11b). The advantage of heating the functional component (2) in this way is that the thermal shock of the melted material with the material of the functional component (1) will not be so aggressive and the formation of carbides in the melted material will be avoided.

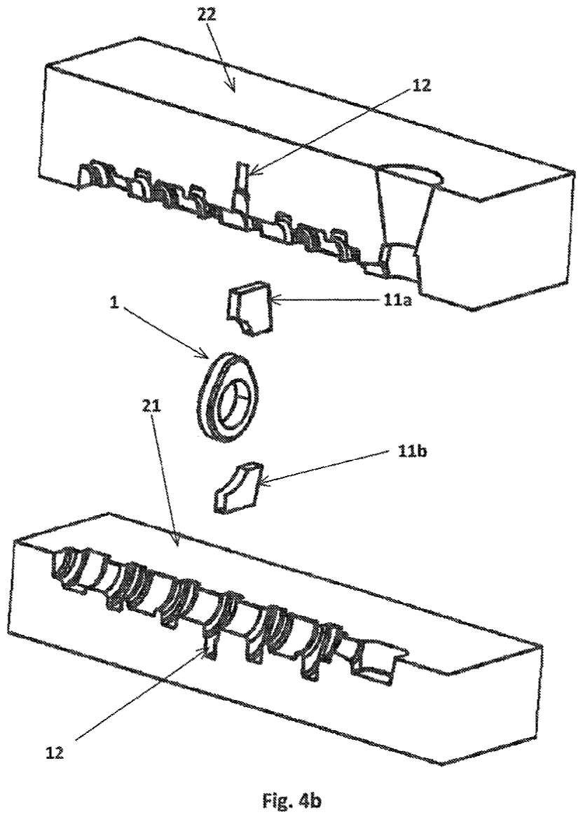

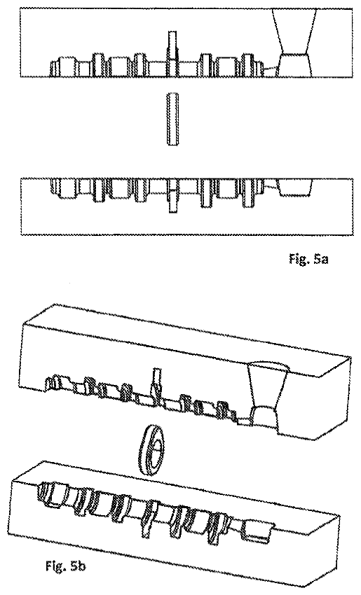

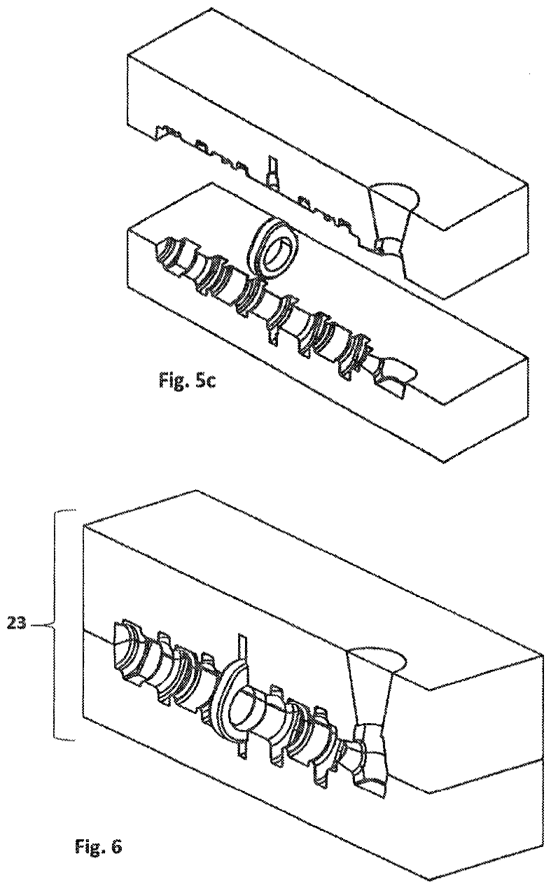

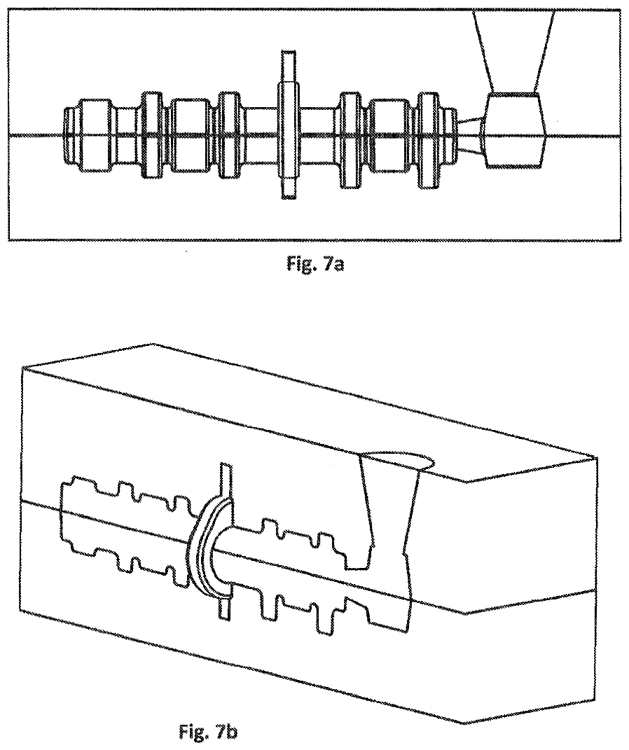

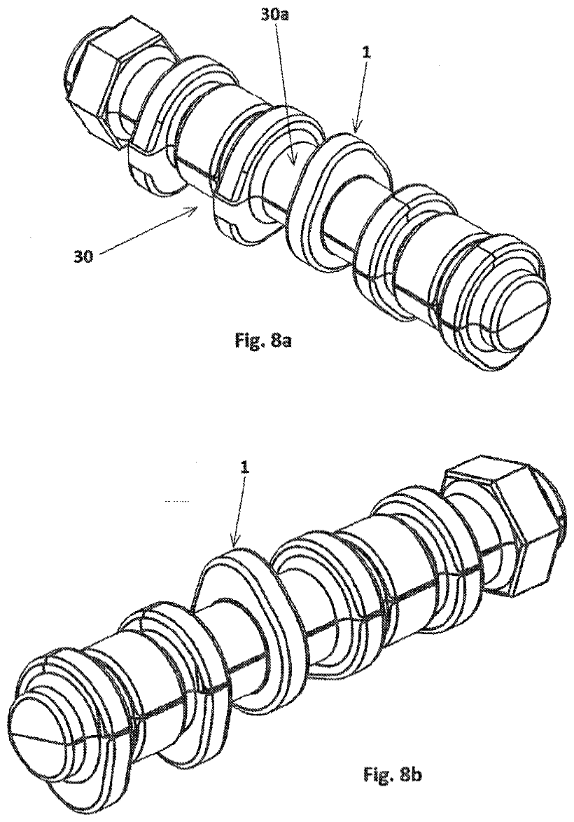

As shown in FIGS. 4a, 4b, 5a-5c, 6, 7a and 7b, the manufacturing process of the present invention consists of the following sequential steps:
a) Preparation of a final mold (23) comprising a lower mold part (21) and an upper mold part (22), which will serve for the casting process, said mold will be processed in a traditional manner to said process, locating (11a, 11b) necessary for the functional component(s), said heaters (11a, 11b) are positioned from the time of making the mold;
b) Placing one or more functional components (1) of the A-type material for each necessary cavity (12) of the shaft(s) in the lower mold (21) used in the casting process, these cavities (12) are the places where the functional components (1) will go and are shapes preformed in the mold, thus, housings for the functional component or components (1) are disposed in the desired end position both in the mold part (21) and in the part (22) of the mold, then both the lower mold part (21) and the upper mold part (22) forming the final mold (23) are closed, and the functional component(s) (1) are closed by The mold in the assigned position;
c) Pouring into the closed mold (23) the melted material (M2) of the B-type, which is steered into the cavities (12) through the filling channels; upon contacting with the heaters (11a, 11b), they are dislodged from the mold by pyrolysis and thus allow the melted material (M2) B-type to come in contact with the functional component(s) (1), allowing to heat externally the functional component(s) (1) and at: the same time to fill the cavities which will form to the melted camshaft of the B-type material, taking into account that the melted material B-type crosses the internal bores (10) of the functional component(s) (1) of A-type material;
d) Expect a time of solidification of the B-type material, which has the shape of the camshaft (30) as illustrated in FIGS. 8a and 8b, which by the prior heating of the functional component (1) of the A-type material a slow and directed solidification is generated in these interface zones of the A-type and B materials, this ensures that the functional component(s) (1) of material A is bonded to the B-type material by a mechanical interference assembly, and coupled to The internal geometry of the functional component(s) (1), that they support the required torques in the performance of their function in an internal combustion engine.

It should be noted that the functional component (1) which comes into contact with the melted material A-type does not reach the required temperature to achieve its melting point, thereby avoiding deformations in both the internal and external geometry and the chemical bonding of both materials.

Important features t:o consider for the functional component (1):
i. It must be of a material with superior characteristics, in some sense, to the base material or the material of the body of the final piece (melted material). These characteristics could be tenacity, hardness, ductility, resistance to friction, higher melting point, among others.
ii. An important feature to note is that the melting point of the material of the functional component must be greater than that of the melted material that will pass through it to avoid degradation of the material.
iii. The manufacture of the functional component is not limited to a specific process, it can be achieved through machining, sintering, printing, plastic, casting and forging.
iv. The external shape of the functional component will depend on the design provided by the customer requesting the final part.
v. The component must have a recess, preferably centered in its own body and concentric to the base body; Said gap will serve to allow the flow of the melted material there through.
vi. The shape of the hollow of the component must, contain at least one shape that serves as an anchor to prevent radial movement and another to prevent longitudinal movement, such as holes or steps respectively, but not exclusively these. The quantity and shape of the anchors will depend on the final geometry of the functional component.
vii. Depending on the melted material, although this should be the case, the edges should be avoided as far as possible at the time of manufacture the bore and the anchors of the functional component, reducing them with rounding or filleting, to allow the melted material to completely fill the same.
viii. It is understood that the terms “round”, “circular” as well as “smooth” should not be understood in a strict mathematical sense, but that the shape of the gap may vary from the pure circle shape due to production tolerances and unavoidable technical inaccuracies.

Important Features to Consider in the Camshaft: Manufacturing Process:
i. It is a process for the industrial scale series production of cast camshafts with at least one functional component of another material, economical and capable of withstanding the mechanical forces in the circumferential direction (torque transmission) and in the longitudinal direction of the shaft carrier.
ii. It is wherein one or several functional components are positioned per cavity of the camshaft(s) which form the cluster of parts in the lower mold, these cavities have arranged housings for the inserts in the desired dimensional position in both the base and the cover of the mold including the foam heaters, the two halves forming the mold are closed and the insert is secured by the mold in the assigned position.
iii. It is wherein post-inoculated B-type molten material is poured into the mold, which is fed into the cavities through the filling channels, this enables the external component(s) to be heated internally, since at the same time they are filled The cavities of the molten shaft when crossing the hollow of the or the same. The molten material, B-type is supplied by at least two feed inlets to ensure a homogeneous temperature within the part. And from this moment the solidification of the molten shaft of the B-type material begins, which by the previous heating of or the functional components of the A-type material generates a slow and directed solidification in these interface zones of the materials A and B, This ensures that the functional component(s) of A-type material are bonded to the B type casting material by mechanical interference assembly and, together with the internal geometry of the functional component is), can withstand the torques required for an internal combustion engine.
iv. It is characterized by a post-inoculation achieved by the use of a chemical element which is part of the rare earth family in sufficient quantity to achieve the main objective in combination with the high achieved temperature of the functional component which was heated during the Filling the mold without reaching the melting point, to form nuclei in the B type melt which allow a controlled solidification in the controlled growth in number and size of the crystals of the B-type melt structure. This post-inoculation is performed as close to the mold cavities as to result in the removal of iron carbides at the interface of the functional component(s) and casting shaft.

In the process of the present invention, cast material preferably cast iron has a use range for pouring between 1390 and 1450° C. For the inoculant the material used is Ferro-silicon, enriched with element strontium.

1. A camshaft manufacturing process comprising the steps of:
a) Forming a final mold (23) comprising a lower mold part (21) and an upper mold part (22), which will be used for a casting process, by previously locating in place heaters (11a, 11b) required for one or more functional components (1);
b) Placing one or more functional components (1) of a A-type material in at least one cavity (12) or the shafts at the bottom of the mold (21) used in the casting process, wherein the one or more functional components (1) have the function of being an assembly insert; wherein the one or more functional components (1) comprises a body with an internal gap (10) of suitable geometry for passing a B-type molten material through a casting process; gripping means which achieve a mechanical grip between both materials, A-type material and B-type material, to give mechanical grip in the longitudinal and circumferential direction with respect to the shaft body;
c) Pouring into the closed mold (23) the molten material (M2) of the B-type, which is fed into the cavities (12) through the filling channels; upon contacting the heaters (11a, 11b), they are dislodged from the mold by pyrolysis and thus allow the molten material (M2) B-type to come in contact with the functional component (1), allowing heating the functional component(s) (1) externally and at the same time filling the cavities which will form the molten camshaft of the B-type material, taking into account that the molten material (M2) B-type crosses the internal bores (10) of the functional components (1) of the A-type material;
d) Wait for a solidification time of the B-type material, which has the shape of the camshaft (30).

2. The camshaft manufacturing process according to claim 1, wherein in step a), the mold is traditionally processed in the process.

3. The camshaft manufacturing process according to claim 1, wherein in step a), the heaters (11a, 11b) are positioned from the moment the mold is made.

4. The camshaft manufacturing process according to claim 1, wherein the heaters (11a, 11b) are foam or similar material.

5. The camshaft manufacturing process according to claim 1, wherein in step b), the cavities (12) are/is the place(s) where the functional components (1) will go, and are shapes preformed in the mold, as well, housings for the functional component (1) are arranged in the desired final position both in the mold bottom (21) and in the upper mold part (22) of the final mold (23), thereafter closing both the mold part (21) as the mold top (22) forming the mold (23) and the functional component(s) (1) are secured by the mold in the assigned position.

6. The camshaft manufacturing process according to claim 1, wherein in step d), a prior heating of the functional component(s) (1) of the A-type material generates a slow and directed solidification in these interface regions of A and B materials, this ensures that the functional component(s) (1) of the material A are bonded to the B-type material by a mechanical interference assembly, and coupled to the internal geometry of the functional component(s) (1), that the same support the required torques in the performance of their function in an internal combustion engine.

7. The camshaft manufacturing process according to claim 1, wherein the functional component in step b) is made of a A-type molten material, preferably steel (to support higher contact stress, either with or without heat treatment), to be attached to the shaft made by casting during the solidification process, and thus allowing correct fastening for torque transmission and longitudinal gripping.

8. The camshaft manufacturing process according to claim 1, wherein the gripping means of the functional component in step b), is an internal bore (10) with geometry consisting of a borehole passed through the component (1), wherein, starting from said bore, two steps (2a, 2b) are generated, starting from the center of the track and towards the outside of the track, one on each side and a larger diameter, which will serve to provide mechanical grip in the longitudinal direction relative to a camshaft body.

9. The camshaft manufacturing process according to claim 1, wherein the gripping means of the functional component in step b), along circumferences (2c) generated by the borehole and the steps (2a, 2b), at least one smaller diameter borehole (3) is generated, where its horizontal central axis (3a) is tangent to the circumference (2c) generated by the steps (2a, 2b), wherein said borehole (3) serves to give mechanical grip in the circumferential direction relative to a body of the camshaft.

10. The camshaft manufacturing process according to claim 1, wherein there is a post-inoculation achieved by the use of a chemical element which forms part of the rare earth family in sufficient quantity to achieve the main objective, in combination with the high temperature achieved of the functional component which was heated during filling of the mold without reaching the melting point, to form nuclei in the molten B-type material which allow controlled solidification in directed controlled growth in number and size of the solid crystals characteristic of the structure of the B-type molten material, wherein said post-inoculation is performed as close as possible to mold cavities to result in the removal of iron carbides at the interface of the functional component(s) and the cast shaft.

11. The camshaft manufacturing process according to claim 1, wherein the B-type molten material is preferably cast iron with a use range for pouring between 1390 and 1450° C., wherein the material used as the inoculant is Ferro-silicon, enriched with strontium element.

12.-19. (canceled)
